(19) United States
(12) Patent Application Publication
(10) Pub. No.: US 2026/0142394 A1
(43) Pub. Date: May 21, 2026

(54) ELECTRICAL CONNECTOR AND ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: HAOZHE ZI, Irvine, CA (US); TERRANCE F. LITTLE, Fullerton, CA (US); AN-JEN YANG, Irvine, CA (US)

(21) Appl. No.: 18/953,503

(22) Filed: Nov. 20, 2024

(51) Int. Cl. H01R 12/71; H01R 12/75; H01R 13/24; H01R 13/514; H01R 13/6587

(52) U.S. Cl. CPC H01R 12/714; H01R 12/75; H01R 13/2435; H01R 13/514; H01R 13/6587

(57) ABSTRACT

An electrical connector includes: a terminal module including: an insulating body; a cable; plural signal terminals held on the insulating body and arranged in pairs and in a row; and a grounding member including plural grounding pieces arranged on both sides of each pair of signal terminals and a common grounding piece connected with the plural grounding pieces, wherein the cable comprises a pair of signal conductors and a conductive layer, each grounding piece includes a first ground portion extending from one side of the insulating body toward a mating direction beyond the signal terminals, each signal terminal has a first contact portion connected with the signal conductor of the cable and a second contact portion for connecting with a mating connector, and the first contact portion and the second contact portion are both in a plane perpendicular to the first ground portion.

### BACKGROUND OF THE INVENTION

### Field of the Invention

The present invention generally relates to an electrical connector and electrical connector assembly to transmit high-speed differential signals.

### Description of Related Arts

U.S. Pat. No. 11,616,313 discloses a structure of connecting cable conductors to signal pads that are provided in a signal layer of a board where the conductors are each attached to a support via by laser welding and the support via is connected by a short trace to the signal pad. To connect a shield layer of the cable to ground pads or ground plane on the board, a pedestal may be provided.

U.S. Pat. No. 9,735,495 discloses an electrical cable assembly including a cable end connector, a complementary electrical connector connected with the cable end connector, a substrate on which complementary connector is mounted. The cable end connector includes a plurality of leadframe assemblies each having a housing, a plurality of electrical contacts disposed in the housing, and a shield member. Each electrical contact is an elongated structure extending in a direction parallel to the cable, one end of the electrical contact is connected with the cable, and the other end of the electrical contact is connected with the complementary electrical connector. U.S. Pat. No. 9,455,534 discloses an cable connector including an insulating base with a plurality of openings and a plurality of signal pair units housed in the insulating base and each signal pair unit includes a pair of elongated conductive terminals, a support frame supporting the conductive terminals, and a grounding shield connected to the support frame. The conductive terminals extend parallel to the mating direction, one end of the conductive terminal is connected with the cable, and the other end of the conductive terminal is connected with the mating connector. The space utilization of the connector mentioned above can be improved and, therefore, an improved electrical connector design is desired.

### SUMMARY OF THE INVENTION

The main object of the present invention is to provide an improved electrical connector with effective space utilization.

To achieve the above-mentioned object, an electrical connector adapted for being connected to a mating connector comprises: an insulating housing; and a terminal module held in the insulating housing and comprising: an insulating body; a cable extending along a first direction; a plurality of signal terminals held on the insulating body and arranged in pairs and in a row along a second direction perpendicular to the first direction; and a grounding member comprising a plurality of grounding pieces arranged on both sides of each pair of signal terminals and a common grounding piece connected with the plurality of grounding pieces, wherein the cable comprises a pair of signal conductors connected with a corresponding pair of signal terminals and a conductive layer electrically connected with the grounding member, each grounding piece comprises a first ground portion extending from one side of the insulating body toward a mating direction beyond the signal terminals, each signal terminal comprises a first contact portion connected with the signal conductor of the cable and a second contact portion connected with the mating connector, and the first contact portion and the second contact portion are both in a plane perpendicular to the first ground portion.

To achieve the above-mentioned object, an electrical connector adapted for being mounted on a circuit board comprises: an insulating housing comprising a bottom wall and side walls around the bottom wall to form a receiving space, the bottom wall having a plurality of through holes; a plurality of terminals held in the through holes and arranged in pairs each comprising a first terminal and a second terminal for transmitting differential signals; and a ground shield member held in the insulating housing and arranged around each pair of terminals, wherein each first terminal comprises a first elastic arm and a first connecting portion respectively exposed from both sides of the through hole, each second terminal comprises a second elastic arm and a second connecting portion respectively exposed from both sides of the through hole, the first elastic arm and the second elastic arm are exposed in the receiving space and extend obliquely in opposite directions, and the ends of the first elastic arm and the second elastic arm are respectively provided with a first mating portion and a second mating portion both in a plane parallel to the bottom wall.

To achieve the above-mentioned object, an electrical connector assembly comprises: a circuit board; an electrical connector connected with the circuit board and comprising an insulating housing and a plurality of mating terminals arranged in pairs and arranged in a plurality of rows and columns held in the insulating housing; and a first connector connected with the electrical connector and comprising a plurality of stacked terminal modules, each terminal module comprising: an insulating body; a cable extending along a first direction; a plurality of signal terminals connected with the cable and held on the insulating body, the plurality of signal terminals being arranged in pairs and in a row along a second direction perpendicular to the first direction; and a plurality of grounding pieces arranged on both sides of each pair of signal terminals, wherein each mating terminal of the electrical connector comprises an elastic arm exposed from one end of the insulating body and a soldering pad exposed from the other end of the insulating body and connected to the circuit board, the end of the elastic arm is provided with a mating portion connected to the first connector, the mating portions of the electrical connector are all in a plane parallel to the circuit board, one end of each grounding piece of the first connector extends from one side of the insulating body toward a mating direction beyond the signal terminals, each signal terminal of the first connector comprises a first contact portion connected with the cable and a second contact portion connected with the mating portion of electrical connector, and the first contact portion and the second contact portion are both in a plane perpendicular to the grounding piece.

### BRIEF DESCRIPTION OF DRAWINGS

FIG. 1 is a perspective view of an electrical connector assembly, wherein other connector is provided on the circuit board;

FIG. 2 is a perspective view of the electrical connector and first connector shown in FIG. 1;

FIG. 3 is a perspective view of the first connector shown in FIG. 1;

FIG. 4 is a further exploded view of the first connector shown in FIG. 3;

FIG. 5 is a perspective view of two terminal modules of the first connector shown in FIG. 4;

FIG. 6 is another perspective view of two terminal modules of the first connector shown in FIG. 5;

FIG. 7 is a perspective view of one terminal module of the electrical connector shown in FIG. 5;

FIG. 8 is an exploded view of the terminal module shown in FIG. 7;

FIG. 9 is another exploded view and a partial enlarged view of the terminal module shown in FIG. 8;

FIG. 10 is an exploded view of one terminal module of the first connector shown in FIG. 9;

FIG. 11 is a perspective view and a partial enlarged view of the electrical connector shown in FIG. 2;

FIG. 12 is an another perspective view and a partial enlarged view of the electrical connector shown in FIG. 2;

FIG. 13 is a perspective view and a partial enlarged view of the electrical connector shown in FIG. 11, wherein the insulating housing is removed;

FIG. 14 is an another perspective view and a partial enlarged view of the electrical connector shown in FIG. 12, wherein the insulating housing is removed;

FIG. 15 is a perspective view of a pair of terminals shown in FIG. 11;

FIG. 16 is a partial enlarged view of the electrical connector assembly shown in FIG. 1, wherein the insulating housing of the electrical connector and the first connector are removed; and

FIG. 17 is a partial cross-sectional view of the electrical connector assembly shown in FIG. 1 along line A-A.

### DETAILED DESCRIPTION OF DRAWINGS

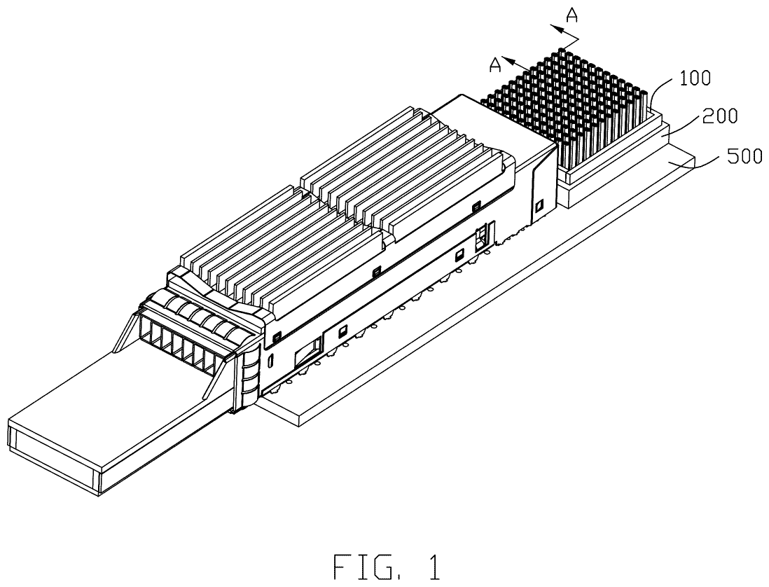

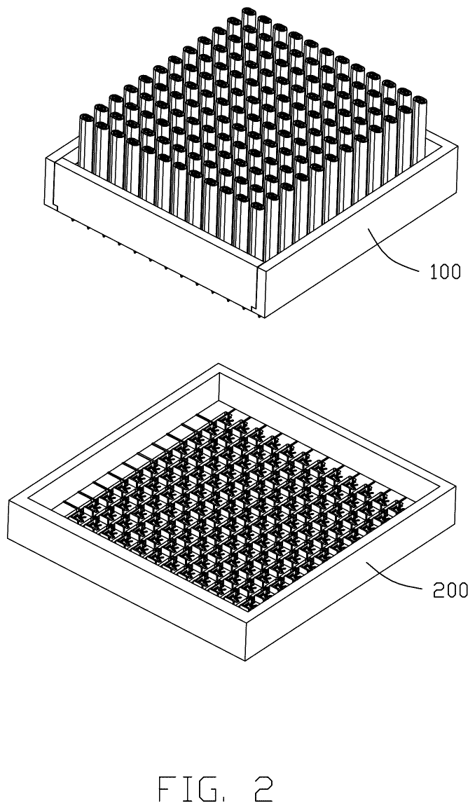

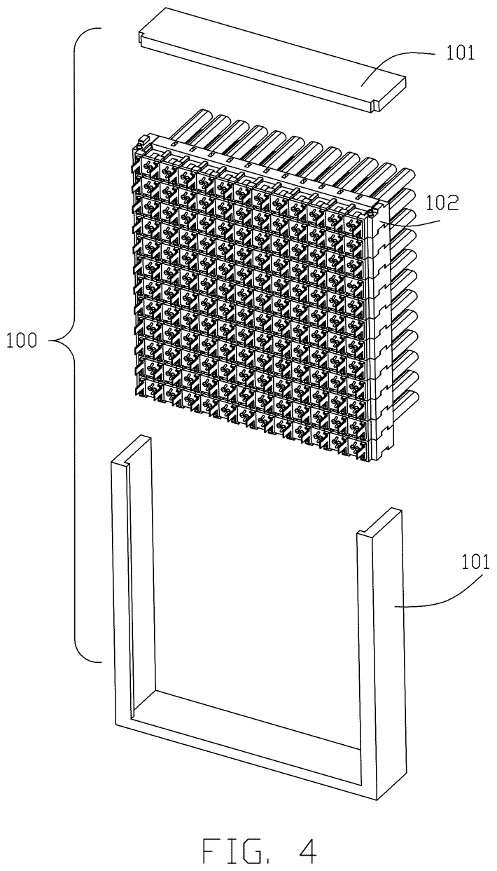

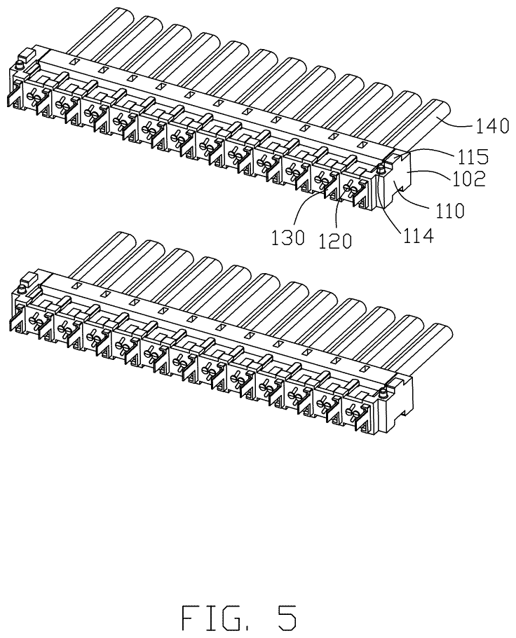

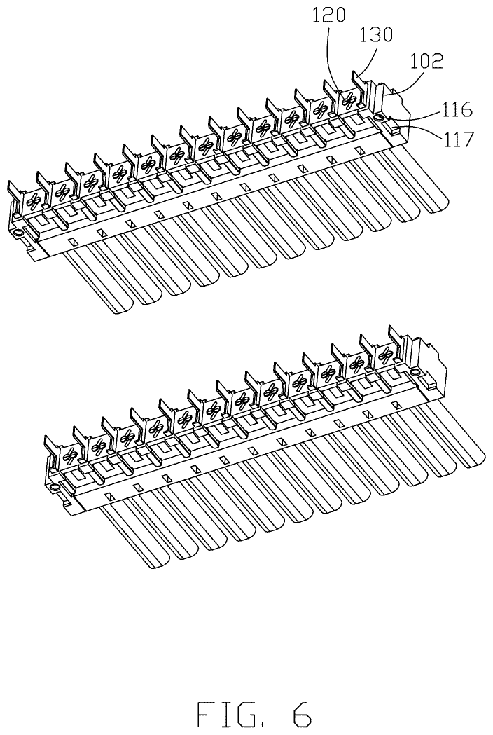

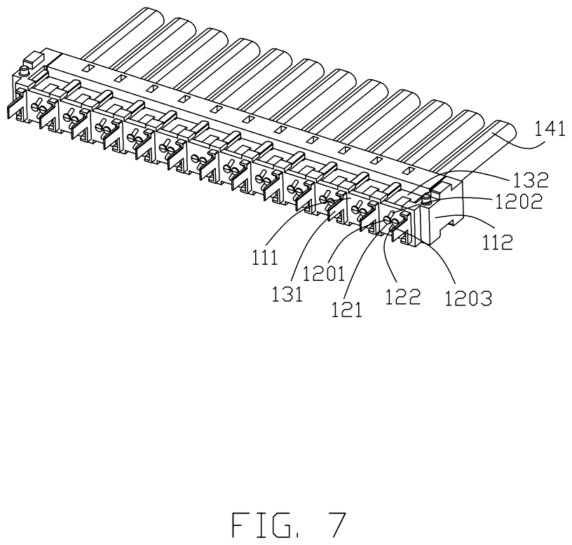

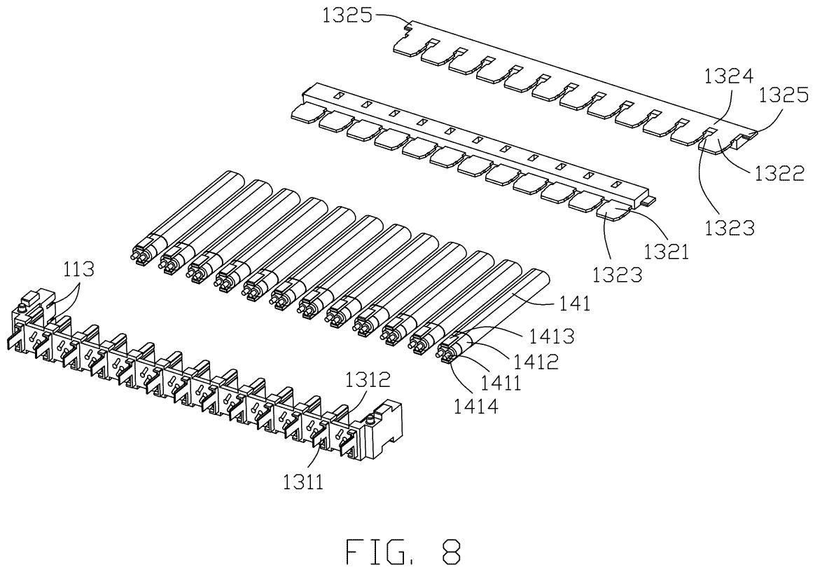

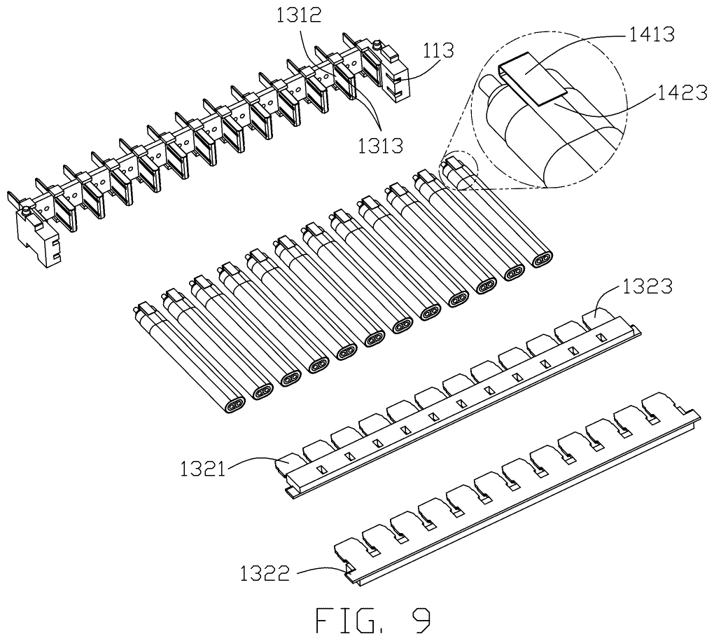

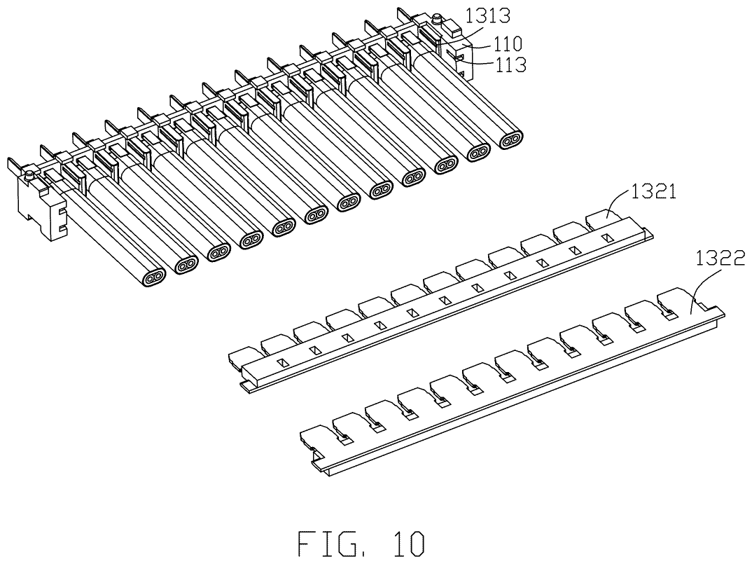

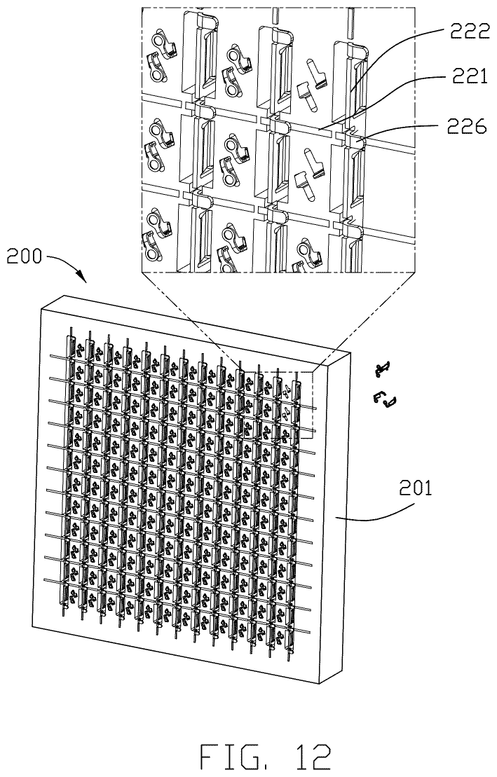

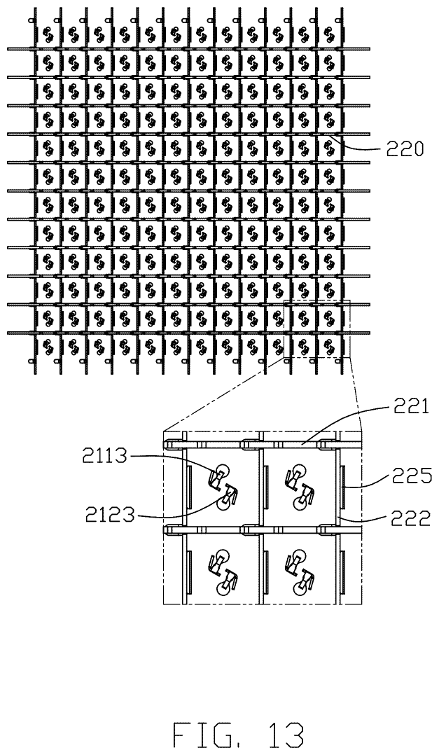

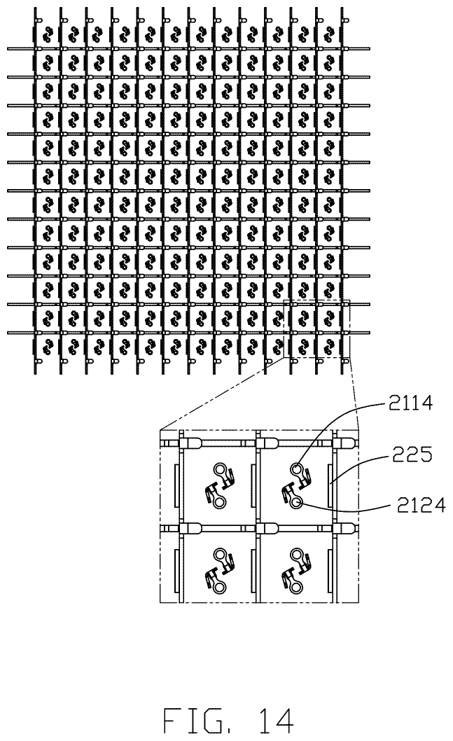

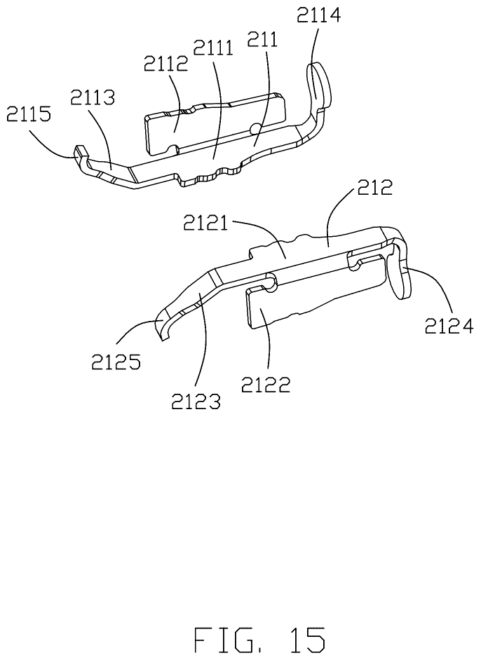

Referring to FIGS. 1-17, an electrical connector assembly 1000 includes a circuit board 500, an electrical connector 200 mounted on the circuit board, and a first connector 100 connected with the electrical connector 200.

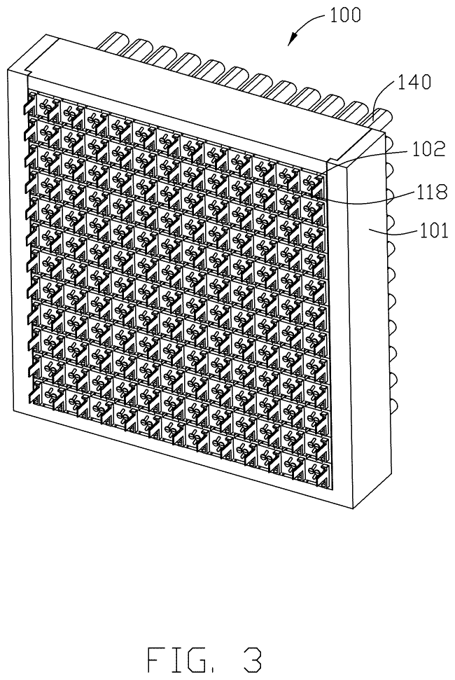

Referring to FIGS. 3-10, the first connector 100 includes an insulating housing 101 and a plurality of terminal modules 102 stacked up and down and held in the insulating housing 101. The terminal module 102 includes an insulating body 110, a plurality of signal terminals 120 and a grounding member 130 integrally formed with the insulating body 110, and a cable 140 extending in the first direction connected correspondingly to the signal terminal 120 and the grounding member 130. A plurality of the signal terminals 120 are arranged in pairs and in a row along a second direction perpendicular to the first direction, including first signal terminals 121 and second signal terminals 122 for transmitting differential signals. In this embodiment, the first connector 100 has 12 terminal modules stacked up and down, and each terminal module 102 includes 12 pairs of signal terminals. In other embodiments, the number of terminal modules 102 and the number of signal terminals 120 can be designed according to specific requirements. The grounding member 130 includes a plurality of grounding pieces 131 provided on both sides of each pair of the signal terminals 120 and a common grounding piece 132 connected to the plurality of grounding pieces 131. The cable 140 includes a plurality of drainless twinax cables 141 arranged in a row. The twinax cable 141 includes two signal conductors 1411 correspondingly connected to each pair of the signal terminals 120 and a conductive layer 1412 disposed outside the two signal conductors 1411 and electrically connected to the grounding pieces 131.

The insulating body 110 includes a main body portion 111 holding the signal terminal 120 and the grounding piece 131 and two side portions 112 provided on both sides of the main body portion 111. The signal terminal 120 includes a first contact portion 1201 connected with the signal conductor 141 and a second contact portion 1202 arranged at an angle with the first contact portion 1201 and connected with the electrical connector 200. The first contact portion 1201 and the second contact portion 1202 are entirely embedded in the main body portion 111 and are in the same plane perpendicular to the first direction. The first contact portion 1201 has a circular through-hole structure. After the signal conductor 1411 passes through the through-hole, the signal conductor 1411 is mechanically and electrically connected with the first contact portion 1201 through laser welding. The second contact portion 1202 is in a strip shape, The second contact portions 1202,1203 of the two signal terminals 120 arranged in pairs are parallel to each other and extend obliquely in opposite directions from the corresponding first contact portion 1201. The first contact portion 1201 and the second contact portion 1202 are directly connected or formed integrally. In this way, the design of the signal terminal increases space utilization as much as possible. The signal conductor 1411 is naturally connected with the first contact portion 1201 of the signal terminal 120, and if the pitch between two signal conductors needs to be reduced according to design requirements, such a design can also meet the requirements.

Each grounding piece 131 includes a first ground portion 1311 and a second ground portion 1312. The first ground portion 1311 extends from one side of the insulating body 110 to the mating direction and beyond the signal terminals 120, and the second ground portion 1312 extends from the other side of the insulating body to the cable direction and is connected with the common grounding piece 132. The common grounding piece 132 includes a first common grounding piece 1321 and a second common grounding piece 1322 respectively provided on the upper and lower sides of the twinax cable 141. The first common grounding piece 1321 and the second common grounding piece 1322 are respectively held by an insulating block and have the same structure. Each piece 1321 or 1322 includes a plurality of sub-common ground pieces 1323 arranged at intervals and a base portion 1324 connecting each of the sub-common ground pieces. Each of the sub-common ground pieces 1323 is disposed between two adjacent second ground portions 1312. The base portion 1324 is provided with protrusions 1325 on both sides, and both side portions 112 of the insulating body 110 are provided with grooves 113 that can receive the protrusions 1325. The first common grounding piece 1321 and the second common grounding piece 1322 are fixed to the insulating body 110 through the match of the protrusions 1325 and the grooves 113. Two upper and lower chutes 1313 are provided on the inner and outer sides of each second ground portion 1312. Both sides of each sub-common grounding piece 1323 enter the chutes of the two adjacent second ground portions 1312 for connection.

Each twinax cable 141 includes a first conductive sheet 1413 and a second conductive sheet 1414 connected with the conductive layer 1412. The first conductive sheet 1413 extends from the middle position of the upper side of the conductive layer 142 toward the main body portion 111 and is folded upward and then continues to extend toward the cable direction. In this way, a U-shaped structure with the first opening 1423 is formed, and the sub-common grounding piece 1323 of the first common grounding piece 1321 enters the first opening 1423 to connect with the first conductive piece 1413. The second conductive sheet 1414 extends from the middle position of the lower side of the conductive layer 142 toward the main body portion 111 and is folded downward and then continues to extend toward the cable direction. In this way, a U-shaped structure with the second opening is formed, and the sub-common grounding piece 1323 of the second common grounding piece 1322 enters the second opening to connect with the second conductive piece 1414. The first conductive sheet 1413 and the second conductive sheet 1414 and the conductive layer 142 can be manufactured integrally, or they can be manufactured separately and then connected together. The first conductive sheet 1413, the second conductive sheet 1414, and the conductive layer 142 may be manufactured in one piece, or may be manufactured separately and then connected together, and they are all made of copper foil or aluminum foil. The connection between the sub-common grounding piece 1323 and the first conductive piece 1413 and the second conductive piece 1414 can be through contact connection or through laser soldering. The second ground portion 1312 of the grounding piece 131, the first common grounding piece 1321, and the second common grounding piece 1322 form a plurality of rectangular shielding structures respectively surrounding each pair of the signal conductors 1411, thereby reducing crosstalk at this position.

The side portion 112 of the insulating body 110 of each terminal module 102 is provided with a structure that can be fixed to the insulating body of the adjacent terminal module. Specifically, the upper side of each side portion 112 is provided with a positioning post 114 and a limiting block 115, and the lower side is provided with a positioning hole 116 and a limiting groove 117. When multiple terminal modules 102 are stacked up and down, the upper positioning posts 114 and limiting blocks 115 are respectively fixedly installed in the positioning holes 116 and limiting grooves 117 of the adjacent upper terminal modules, the lower positioning holes 116 and limiting grooves 117 receive the positioning posts 114 and limiting blocks 115 of the adjacent lower terminal modules. In this way, the terminal modules 102 are tightly assembled row by row and kept in the correct position. The main body portion 111 is provided with inward notch structures on both upper and lower sides corresponding to the position of the signal terminal 120. When a plurality of the terminal modules 102 are stacked one on another, the notches of the two terminal modules 102 on adjacent sides form a rectangular slot 118.

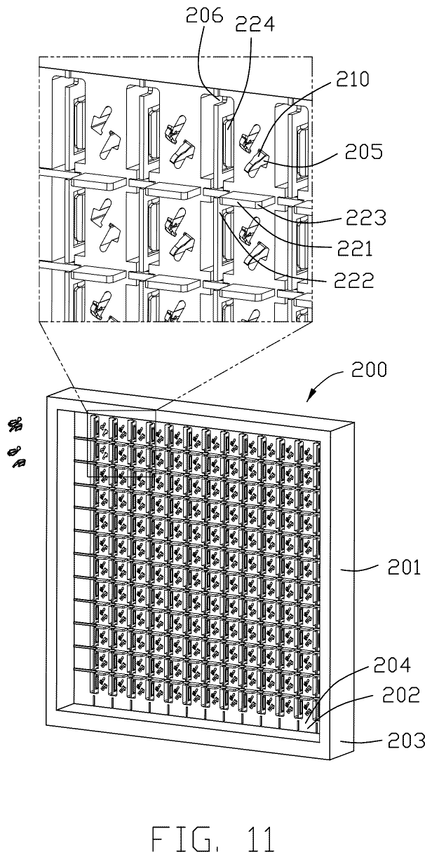

Referring to FIGS. 11-15, the electrical connector 200 includes an insulating housing 201, a plurality of terminals 210 held in the insulating housing 201, and a grounding shield member 220 held in the insulating housing 201. A plurality of the terminals 210 are arranged in pairs, including multiple pairs of first terminals 211 and second terminals 212 for transmitting differential signals. The insulating housing 201 includes a bottom wall 202 and four side walls 203 arranged around the bottom wall 202. The bottom wall 202 and the four side walls 203 together form a receiving space 204 that can receive the first connector 100. The bottom wall 202 is provided with paired through holes 205 for holding the terminals. The first terminal 211 and the second terminal 212 have the same structure and are arranged oppositely. The first terminal 211 includes a first main body part 2111 held in the through hole 205, a second main body part 2112 bent and extended from the side edge of the first main body part 2111 and held in the through hole 205, a first elastic arm 2113 extended upward and obliquely at an angle with one side of the first main body 2111, and a first connecting portion 2114 extended upward and perpendicular to the other side of the first body 2111. The second terminal 212 includes a first main body part 2121 held in the through hole 205, a second main body part 2122 bent and extended from the side edge of the first main body part 2121 and held in the through hole 205, a second elastic arm 2123 extended downward and obliquely at an angle with one side of the first main body 2121, and a second connecting portion 2124 extended downward and perpendicular to the other side of the first body 2121. The first elastic arm 2113 and the second elastic arm 2123 are both exposed in the receiving space 204. The free ends of the first elastic arm 2113 and the second elastic arm 2123 are provided with a first mating portion 2115 and a second mating portion 2125 respectively connected with the second contact portion 1202, 1203 of the first connector 100. The first mating portion 2115 and the second mating portion 2125 are both in a plane parallel to the bottom wall 202. The first connecting portion 2114 and the second connecting portion 2124 are SMT pads connected with the circuit board 500.

The through holes 205 are arranged in the bottom wall 202 in a plurality of rows and columns, and a plurality of pairs of terminals 210 are arranged in a plurality of rows and columns in the corresponding through holes 205. In this embodiment, the terminals 210 are arranged in a square shape and arranged in 12 rows and 12 columns. In other embodiments, it can also be arranged in a 3*3, or 6*6, or 8*8 arrangement, which is not limited by this application. The ground shield 220 includes a plurality of first ground shield pieces 221 and second ground shield pieces 222 arranged in rows and columns. The plurality of first ground shield pieces 221 and the second ground shield pieces 222 form a plurality of shielding cavities respectively surrounding each pair of the terminals 210. In this embodiment, the ground shield member 220 includes 11 first ground shield pieces 221 arranged laterally and 13 second ground shield pieces 222 arranged longitudinally. Except for the terminals 210 in the first and last rows being surrounded by the first ground shield pieces 221 and the second ground shield pieces 222 in three directions, the remaining terminals 210 are surrounded by the first ground shield pieces 221 and the second ground shield pieces 222 in four directions. The first ground shield piece 221 includes a plurality of mating tabs 223 protruding to the receiving space 204. The bottom wall 202 is provided with a plurality of channels 206 located on both sides of each pair of terminals. The second ground shield piece 222 is provided with a contact elastic piece 224 exposed in the channel 206. The contact elastic piece 224 is provided with first contact protrusion 225. The second ground shield piece 222 is also provided with a plurality of grounding pins 226 extending toward the circuit board 500 and connected to the circuit board 500.

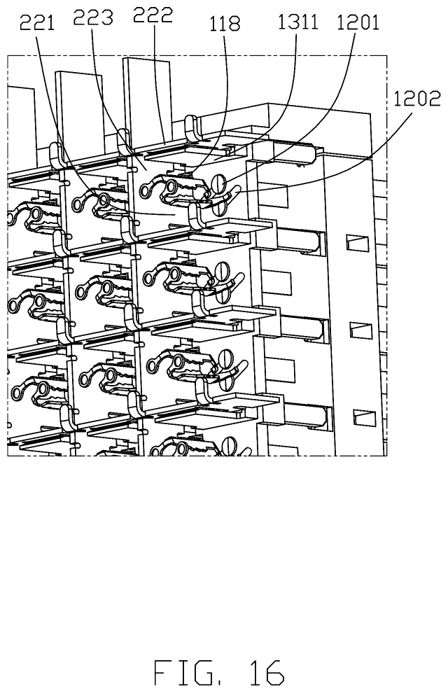

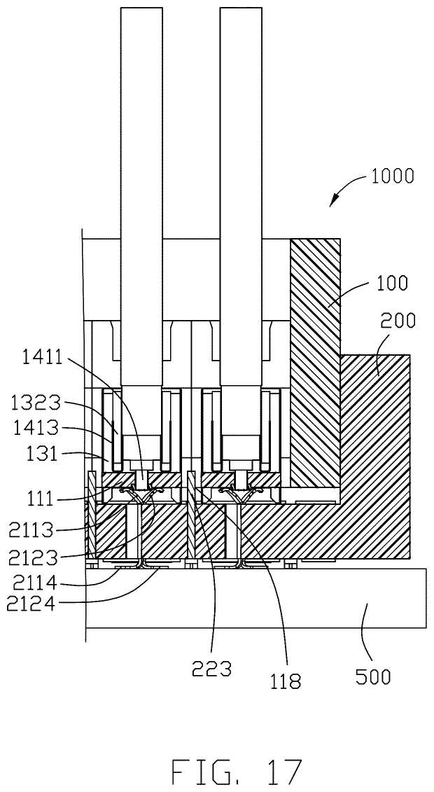

Referring to FIGS. 16-17, when the electrical connector 200 is connected with the first connector 100, the first mating portion 2115 and the second mating portion 2125 on one side of the electrical connector 200 are abutted and connected with the corresponding second contact portion 1202, 1203 of the first connector 100. Each first ground portion 1311 of the first connector 100 extends into the channel 206 of the electrical connector 200, and is in contact with the contact protrusion 225. A vertical shielding wall is established between each pair of high-speed differential signals in the vertical direction. Each mating tab 223 of the first ground shield piece 221 of the electrical connector 200 extends into the rectangular slot 118 between the adjacent terminal modules 102 of the first connector 100. A horizontal shielding wall is established between each pair of high-speed differential signals in the horizontal direction. Except that each pair of high-speed differential signals in the first and last rows is surrounded by vertical shielding walls and horizontal shielding walls in three directions, each remaining pair of high-speed differential signals is completely surrounded by a shielding box formed by vertical shielding walls and horizontal shielding walls in four directions. Therefore, this design effectively controls crosstalk and noise.

The design of the terminal of the first connector in the present invention improves space utilization, the size of the terminal is smaller, and if the distance between the two signal conductors needs to be reduced according to the design requirements, such a design can also meet the requirements. At the same time, the terminal design of the electrical connector is adapted to the terminals of the first connector, which also improves space utilization as much as possible. The connection between the first connector and the electrical connection ensures stable signal transmission and can effectively control crosstalk.

1. An electrical connector adapted for being connected to a mating connector, comprising:
an insulating housing; and
a terminal module held in the insulating housing and comprising:
an insulating body;
a cable extending along a first direction;
a plurality of signal terminals held on the insulating body and arranged in pairs and in a row along a second direction perpendicular to the first direction; and
a grounding member comprising a plurality of grounding pieces arranged on both sides of each pair of signal terminals and a common grounding piece connected with the plurality of grounding pieces; wherein
the cable comprises a pair of signal conductors connected with a corresponding pair of signal terminals and a conductive layer electrically connected with the grounding member, each grounding piece comprises a first ground portion extending from one side of the insulating body toward a mating direction beyond the signal terminals, each signal terminal comprises a first contact portion connected with the signal conductor of the cable and a second contact portion connected with the mating connector, and the first contact portion and the second contact portion are both in a plane perpendicular to the first ground portion.

2. The electrical connector as claimed in claim 1, wherein the first contact portion and the second contact portion are directly connected or formed integrally.

3. The electrical connector as claimed in claim 1, wherein the signal terminal and the grounding piece are integrally formed with the insulating body, and the first contact portion and the second contact portion are embedded in the insulating body.

4. The electrical connector as claimed in claim 1, wherein the first contact portion has a circular through-hole structure, after the signal conductor passes through the through-hole, the signal conductor is mechanically and electrically connected to the first contact portion through welding.

5. The electrical connector as claimed in claim 1, wherein the two second contact portions arranged in pairs are parallel to each other and extend obliquely in opposite directions from the respective first contact portion.

6. The electrical connector as claimed in claim 1, wherein each grounding piece comprises a second ground portion extending from the other side of the insulating body toward the cable and connected with the common grounding piece.

7. The electrical connector as claimed in claim 6, wherein the common grounding piece comprises a first common grounding piece and a second common grounding piece that are perpendicular to the second ground portion and located on the other side of the insulating body, the second ground portion is connected with the first common grounding piece and the second common grounding piece to form a plurality of rectangular shielding structures respectively surrounding each pair of the signal conductors.

8. The electrical connector as claimed in claim 7, wherein each of the first common grounding piece and the second common grounding piece comprising a plurality of sub-common grounding pieces arranged at intervals and a base portion connecting each sub-common grounding piece.

9. The electrical connector as claimed in claim 8, wherein each sub-common grounding piece is engaged between two adjacent second ground portions, and two sides of the base portion are respectively fixed to two sides of the insulating body.

10. The electrical connector as claimed in claim 9, wherein the cable comprises a first conductive sheet and a second conductive sheet connected with the conductive layer, the first conductive sheet is connected to the sub-common grounding piece of the first common grounding piece, and the second conductive sheet is connected to the sub-common grounding piece of the second common grounding piece.

11. The electrical connector as claimed in claim 10, wherein the first conductive sheet extends from one side of the conductive layer toward the insulating body and is folded upward to form a U-shaped structure with a first opening, the sub-common ground piece of the first common grounding piece enters the first opening to connect with the first conductive piece, the second conductive sheet extends from the other side of the conductive layer toward the insulating body and is folded downward to form a U-shaped structure with a second opening, and the sub-common ground piece of the second common grounding piece enters the second opening to connect with the second conductive piece.

12. An electrical connector adapted for being mounted on a circuit board, comprising:
an insulating housing comprising a bottom wall and side walls around the bottom wall to form a receiving space, the bottom wall having a plurality of through holes;
a plurality of terminals held in the through holes and arranged in pairs each comprising a first terminal and a second terminal for transmitting differential signals; and
a ground shield member held in the insulating housing and arranged around each pair of terminals;
wherein each first terminal comprises a first elastic arm and a first connecting portion respectively exposed from both sides of the through hole, each second terminal comprises a second elastic arm and a second connecting portion respectively exposed from both sides of the through hole, the first elastic arm and the second elastic arm are exposed in the receiving space and extend obliquely in opposite directions, and the ends of the first elastic arm and the second elastic arm are respectively provided with a first mating portion and a second mating portion both in a plane parallel to the bottom wall.

13. The electrical connector as claimed in claim 12, wherein the first terminal and the second terminal are arranged oppositely, and both comprises a first main body part held in the through hole, a second main body part bent and extended from the side edge of the first main body part and held in the through hole, the first elastic arm and the second elastic arm respectively extend obliquely from the side of the corresponding first main body part, the first connecting portion and the second connecting portion respectively extend vertically from the other side of the corresponding first main body part.

14. The electrical connector as claimed in claim 13, wherein the first connecting portion and the second connecting portion are exposed from the other end of the through hole and extend in opposite directions and are connected to the circuit board.

15. The electrical connector as claimed in claim 12, wherein the through holes are arranged in a plurality of rows and columns on the bottom wall, and the terminal pairs are arranged in the through holes in a plurality of rows and columns.

16. The electrical connector as claimed in claim 12, wherein the ground shield member comprises a plurality of first ground shield pieces and second ground shield pieces arranged in rows and columns respectively, and the plurality of first ground shield pieces and the second ground shield pieces form a plurality of shielding cavities respectively surrounding each pair of the terminals.

17. The electrical connector as claimed in claim 16, wherein each first ground shield piece comprises a plurality of mating tabs protruding to the receiving space, the bottom wall is provided with a plurality of channels penetrating the bottom wall and on both sides of each pair of terminals, the second ground shield piece is provided with a contact elastic piece that are exposed in each channel, the second ground shield piece comprises a plurality of grounding pins exposed from the other end of the bottom wall and connected to the circuit board.

18. An electrical connector assembly comprising:
a circuit board;
an electrical connector connected with the circuit board and comprising an insulating housing and a plurality of mating terminals arranged in pairs and arranged in a plurality of rows and columns held in the insulating housing; and
a first connector connected with the electrical connector and comprising a plurality of stacked terminal modules, each terminal module comprising:
an insulating body;
a cable extending along a first direction;
a plurality of signal terminals connected with the cable and held on the insulating body, the plurality of signal terminals being arranged in pairs and in a row along a second direction perpendicular to the first direction; and
a plurality of grounding pieces arranged on both sides of each pair of signal terminals;
wherein each mating terminal of the electrical connector comprises an elastic arm exposed from one end of the insulating body and a soldering pad exposed from the other end of the insulating body and connected to the circuit board, the end of the elastic arm is provided with a mating portion connected to the first connector, the mating portions of the electrical connector are all in a plane parallel to the circuit board, one end of each grounding piece of the first connector extends from one side of the insulating body toward a mating direction beyond the signal terminals, each signal terminal of the first connector comprises a first contact portion connected with the cable and a second contact portion connected with the mating portion of electrical connector, and the first contact portion and the second contact portion are both in a plane perpendicular to the grounding piece.

19. The electrical connector assembly as claimed in claim 18, wherein the electrical connector comprises a plurality of first ground shield pieces and second ground shield pieces arranged in rows and columns surrounding each pair of the terminals, a plurality of slots are provided between the insulating bodies on adjacent sides of adjacent terminal modules of the first connector, the first ground shield piece of the electrical connector extends into the corresponding slot of the first connector and the second ground shield piece of the electrical connector is connected with the corresponding grounding piece of the first connector when the first connector is connected with the electrical connector.

20. The electrical connector assembly as claimed in claim 18, wherein the mating terminals of the electrical connector are arranged in same number of rows and columns.
